(19) United States
(12) Patent Application Publication
(10) Pub. No.: US 2026/0075682 A1
(43) Pub. Date: Mar. 12, 2026

(54) INDUCTION COOKER

(71) Applicant: SEF TECH CO., LTD., Taipei City (TW)

(72) Inventors: HAN-CHING LO, Taipei City (TW); LUN-SHAN LIU, Taipei City (TW)

(21) Appl. No.: 18/882,832

(22) Filed: Sep. 12, 2024

(51) Int. Cl. H05B 6/04; H05B 6/06

(52) U.S. Cl. CPC H05B 6/04; H05B 6/062

(57) ABSTRACT

An induction cooker includes a heating module, a working inverter, and a power supply module. The heating module can generate eddy currents in a cookware. The working inverter can output high-frequency power to drive the heating module. The power supply module includes an alternating current (AC) port, a bridge diode, a battery unit, a power switch, and a control unit. The AC power port can output an AC source by utility power. The bridge diode can convert the AC source into a first direct current (DC) power. The battery unit can output a second DC power. The control unit can control the power switch to input the first DC power or the second DC power to the working inverter, so as to generate the high-frequency power.

### FIELD OF THE DISCLOSURE

The present disclosure relates to a cooker, and more particularly to an induction cooker.

### BACKGROUND OF THE DISCLOSURE

Conventional induction cookers provide great convenience in daily life, allowing for quick heating or cooking of food. However, since the conventional induction cookers are designed to operate solely with mains electricity, the conventional induction cookers are unable to be used outdoors. In other words, the conventional induction cookers are dependent on a fixed power supply. Therefore, the conventional induction cookers are limited in usage scenarios (e.g., during camping, picnics, or long-distance travel).

### SUMMARY OF THE DISCLOSURE

In response to the above-referenced technical inadequacy, the present disclosure provides an induction cooker.

In order to solve the above-mentioned problems, one of the technical aspects adopted by the present disclosure is to provide an induction cooker. The induction cooker includes a heating module, a working inverter, and a power supply module. The heating module is capable generating eddy currents in a cookware. The working inverter is capable of outputting high-frequency power to drive the heating module. The power supply module is connected to the working inverter, and includes an alternating current (AC) port, a bridge diode, a battery unit, a power switch, and a control unit. The AC power port is capable of outputting an AC source by utility power. The bridge diode is connected to the AC power port. The bridge diode is configured to convert the AC source into a first direct current (DC) power. The battery unit is capable of outputting a second DC power. The power switch is connected to the bridge diode and the battery unit, and the power switch is configured to switch the first DC power and the second DC power that are input to the working inverter. The control unit is connected to the power switch and the working inverter. The control unit is configured to control the power switch to input the first DC power or the second DC power to the working inverter, so as to generate the high-frequency power. The first DC power has a working voltage that is sufficient to be converted into the high-frequency power for driving the heating module, and a difference between a voltage of the second DC power and the working voltage is less than or equal to 5% of the working voltage.

In one of the possible or preferred embodiments, the control unit includes a power supply, a microcontroller unit, and a power controller. The power supply is connected to the AC power port or the battery unit, and the power supply is configured to generate a low voltage DC power from the AC source. The microcontroller unit is connected to the power supply and is powered by the low voltage DC power. The microcontroller unit is configured to send a control command. The power controller is connected to the microcontroller unit and the working inverter. The power controller is configured to control the high-frequency power generated by the working inverter according to the control command, so as to adjust a strength of the eddy currents.

In one of the possible or preferred embodiments, the control unit includes an input source switch connected between the battery unit and the power switch. The input source switch is configured to create an open circuit or a closed circuit between the battery unit and the power switch under a control of the microcontroller unit. When the open circuit is created by the input source switch, the first DC power is input into the working inverter to generate the high-frequency power. When the closed circuit is created by the input source switch, the second DC power is input into the working inverter to generate the high-frequency power.

In one of the possible or preferred embodiments, the induction cooker includes two voltage dividers respectively connected to the bridge diode and the battery unit. The two voltage dividers are connected to the microcontroller unit, and the two voltage dividers are configured to sample a voltage of the first DC power and a voltage of the second DC power to the microcontroller unit. The microcontroller unit is configured to control the input source switch to create the open circuit or the closed circuit according to the voltage of the first DC power and the voltage of the second DC power that are sampled by the two voltage dividers.

In one of the possible or preferred embodiments, the battery unit includes a plurality of batteries, and the batteries are connected in series, so that the difference between the voltage of the second DC source and the working voltage is less than or equal to 5% of the working voltage.

In one of the possible or preferred embodiments, the induction cooker includes a boost module connected to the battery unit and the working inverter. The boost module is configured to increase the voltage of the second DC source, so that the difference between the voltage of the second DC source and the working voltage is less than or equal to 5% of the working voltage.

In one of the possible or preferred embodiments, the induction cooker includes a line filter connected between the AC power port and the bridge diode. The line filter is configured to filter noise from the AC source before the noise passes into the bridge diode.

Therefore, in the induction cooker provided by the present disclosure, by virtue of “the control unit being configured to control the power switch to input the first DC power or the second DC power to the working inverter, so as to generate the high-frequency power,” and “the first DC power having a working voltage that is sufficient to be converted into the high-frequency power for driving the heating module, and a difference between a voltage of the second DC power and the working voltage being less than or equal to 5% of the working voltage,” the induction cooker can simultaneously use either the AC source or the DC source, and switch between the AC source or the DC source according to situations and requirements.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic circuit block diagram of an induction cooker according to the present disclosure;

FIG. 2 is a schematic circuit diagram of the induction cooker according to the present disclosure; and

FIG. 3 is another schematic circuit diagram of the induction cooker according to the present disclosure;

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on. ” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

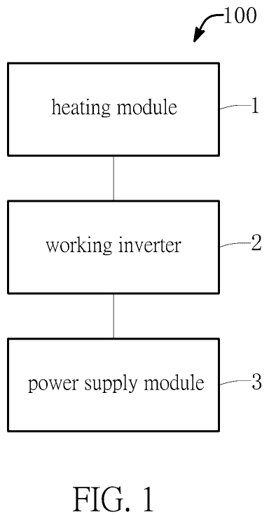

Referring to FIG. 1 to FIG. 3, an embodiment of the present disclosure provides an induction cooker 100, and the induction cooker 100 includes a heating module 1, a working inverter 2 connected to the heating module 1, and a power supply module 3 that is connected to the working inverter 2. The working inverter 2 can output high-frequency power from an alternating current (AC) source or a direct current (DC) source provided by the power supply module 3, so as to drive the heating module 1 to generate eddy currents in a cookware.

In other words, any induction cooker that cannot be powered by either an AC source or a DC source is not the induction cooker 100 of the present disclosure.

Referring to FIG. 1, the heating module 1 in the preset embodiment includes an induction coil (not shown), and a magnetic core (not shown) disposed in the induction coil. Specifically, the induction coil can be exemplified to be a coil wound with a copper wire. When a high-frequency current passes through the induction coil, the induction coil produces a changing magnetic field. The changing magnetic field induces eddy currents a bottom of the cookware, so as to heat the cookware. The magnetic core is surrounded by the induction coil to concentrate and enhance the magnetic field.

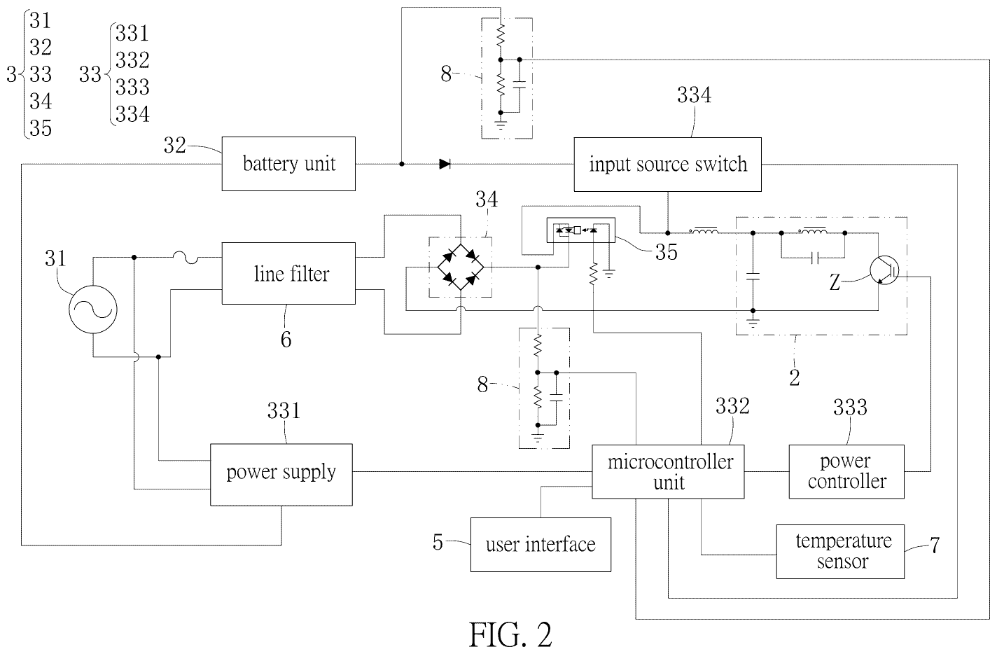

Referring to FIG. 1 and FIG. 2, the working inverter 2 is capable of outputting the high-frequency power to drive the heating module 1.

Referring to FIG. 1 and FIG. 2, the power supply module 3 provides the AC source and the DC source used to generate the high-frequency power. Specifically, the power supply module 3 includes an AC power port 31, a bridge diode 34, a battery unit 32, a power switch 35, and a control unit 33. The AC power port 31 is capable of outputting the AC source by utility power. The bridge diode 34 is connected to the AC power port. The bridge diode 34 can receive the AC source from the AC power port 31, and can convert the AC source into a first DC power. The battery unit 32 is capable of outputting a second DC power.

The power switch 35 is connected to the bridge diode 34 and the battery unit 32, and the power switch 35 is configured to switch the first DC power and the second DC power that are input to the working inverter 2.

The working inverter 2 can receive the first DC power and the second DC power and convert one of the first DC power and the second DC power into an AC power that has a high-frequency (i.e., the high-frequency power). Consequently, the working inverter 2 causes changes in the magnetic field of the induction coil through the high-frequency power.

The control unit 33 is connected to the power switch 35 and the working inverter 2, and the control unit 33 can control the power switch to input the first DC power or the second DC power to the working inverter 2, so as to generate the high-frequency power.

In detail, the control unit 33 can be exemplified to include a power supply 331, a microcontroller unit (MCU) 332, a power controller 333, and an input source switch 334.

The power supply 331 is connected to the AC power port 31 or the battery unit 32, and the power supply 331 is configured to generate a low voltage DC power from the AC source or the battery unit 32. The MCU 332 is connected to the power supply 331 and the MCU 332 can operate and use the low voltage DC power.

The input source switch 334 is connected between the MCU 332 and the working inverter 2, and the input source switch 334 is configured to create an open circuit or a closed circuit between the battery unit 32 and the power switch 35 under the control of the MCU 332. When the open circuit is created by the input source switch 334, the first DC power is input into the working inverter 2 to generate the high-frequency power. Conversely, when the closed circuit is created by the input source switch 334, the second DC power is input into the working inverter 2 to generate the high-frequency power. In other words, through the control of the input source switch 334, either the first DC power or the second DC power, but not both, can enter the working inverter 2.

Moreover, the induction cooker 100 can also include two voltage dividers 8 respectively connected in parallel with the AC power port 31 and the battery unit 32. The two voltage dividers 8 that are connected in series with the MCU 332, and the two voltage dividers 8 are configured to sample a voltage of the first DC power and a voltage of the second DC power to the MCU 332. The MCU 332 can control the input source switch 334 to create the open circuit or the closed circuit according to the voltage of the first DC power and the voltage of the second DC power that are sampled by the two voltage dividers 8.

For example, when the MCU 332 determines that a power of the battery unit 32 is insufficient based on the information of the second DC power, the MCU 332 controls the input source switch 334 to create the open circuit, thereby allowing the first DC power to be used. Conversely, when the MCU 332 determines that the AC power port 31 cannot supply power (e.g., during a power outage) based on the information of the first DC power, the MCU 332 controls the input source switch 334 to create the closed circuit, allowing the second DC power to be used.

Moreover, the power controller 333 is connected to the MCU 332 and the working inverter 2, and the power controller 333 can control the high-frequency power generated by the working inverter 2 according to a control command from the MCU 332 based on an input from an user interface 5 of the induction cooker 100, thereby adjusting the strength of the eddy currents. In practice, the control command can be input by the user through the user interface 5 that is connected to the MCU 332.

In addition, it is worth mentioning that the AC source and the DC source used to generate the high-frequency power in the induction cooker 100 have nearly identical voltages within the working inverter 2. Specifically, the first DC power converted by the AC source has a working voltage that is sufficient to be converted into the high-frequency power for driving the heating module 1, and a difference between a voltage of the second DC power and the working voltage is less than or equal to 5% of the working voltage.

In practice, the voltage of the second DC power from the battery unit 32 can be achieved by connecting a plurality of batteries in series (i.e., the battery unit 32 includes a plurality of batteries, and the batteries are connected in series), but the present disclosure is not limited thereto.

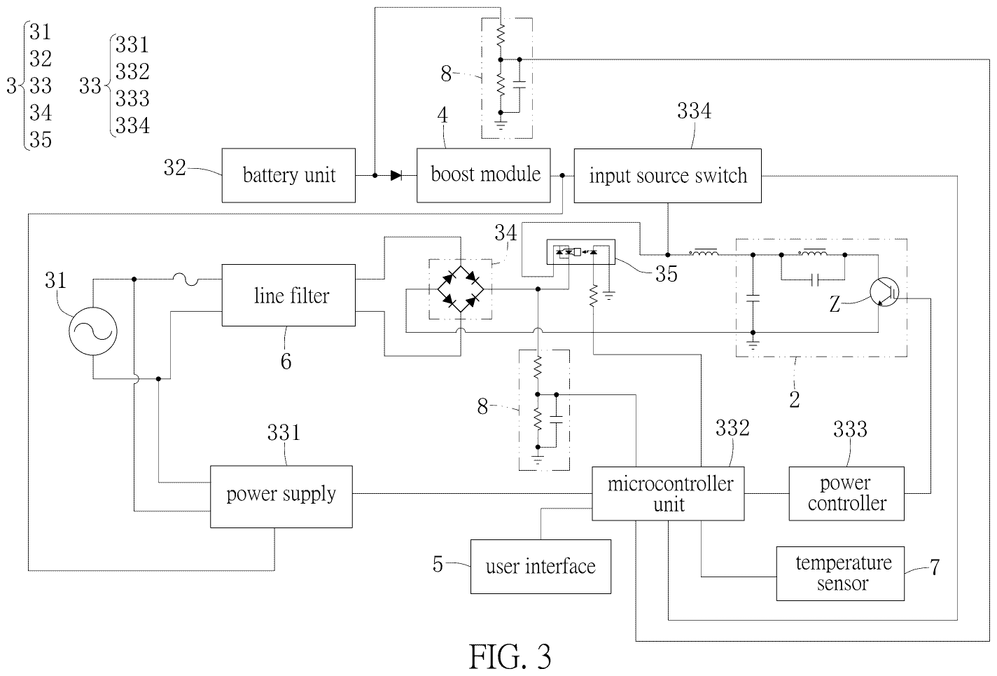

For, example, the induction cooker 100 can be exemplified to include a boost module 4 connected to the battery unit 32 and the working inverter 2, and the boost module 4 is configured to increase the voltage of the DC source (as shown in FIG. 3).

Preferably, in order to avoid instability in heating when the induction cooker 100 is using an AC source, the induction cooker 100 can include a line filter 6 connected between the AC power port 31 and the bridge diode 34, and the line filter 6 is configured to filter noise from the AC source before the noise passes into the bridge diode 34.

Moreover, the induction cooker 100 can include a temperature sensor 7 connected to the MCU 332, and the temperature sensor 7 can detect at least one of a temperature of the induction coil or a temperature of an insulated-gate bipolar transistor (IGBT) Z to generate a temperature information, so as to send the temperature information to the MCU 332 for use.

### Beneficial Effects of the Embodiment

In conclusion, in the induction cooker provided by the present disclosure, by virtue of “the control unit being configured to control the power switch to input the first DC power or the second DC power to the working inverter, so as to generate the high-frequency power,” and “the first DC power having a working voltage that is sufficient to be converted into the high-frequency power for driving the heating module, and a difference between a voltage of the second DC power and the working voltage being less than or equal to 5% of the working voltage,” the induction cooker can simultaneously use either the AC source or the DC source, and switch between the AC source or the DC source according to situations and requirements.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An induction cooker, comprising:
a heating module capable of generating eddy currents in a cookware;
a working inverter capable of outputting high-frequency power to drive the heating module; and
a power supply module connected to the working inverter, wherein the power supply module includes:
an alternating current (AC) power port capable of outputting an AC source by utility power;
a bridge diode connected to the AC power port, wherein the bridge diode is configured to convert the AC source into a first direct current (DC) power;
a battery unit capable of outputting a second DC power;
a power switch connected to the bridge diode and the battery unit, wherein the power switch is configured to switch the first DC power and the second DC power that are input to the working inverter; and
a control unit connected to the power switch and the working inverter, wherein the control unit is configured to control the power switch to input the first DC power or the second DC power to the working inverter, so as to generate the high-frequency power, and wherein the first DC power has a working voltage that is sufficient to be converted into the high-frequency power for driving the heating module, and a difference between a voltage of the second DC power and the working voltage is less than or equal to 5% of the working voltage.

2. The induction cooker according to claim 1, wherein the control unit includes:
a power supply connected to the AC power port or the battery unit, wherein the power supply is configured to generate a low voltage DC power from the AC source or the battery unit;
a microcontroller unit connected to the power supply and powered by the low voltage DC power, wherein the microcontroller unit is configured to send a control command; and
a power controller connected to the microcontroller unit and the working inverter, wherein the power controller is configured to control the high-frequency power generated by the working inverter according to the control command, so as to adjust a strength of the eddy currents.

3. The induction cooker according to claim 2, wherein the control unit includes an input source switch connected between the battery unit and the power switch, wherein the input source switch is configured to create an open circuit or a closed circuit between the battery unit and the power switch under a control of the microcontroller unit; wherein, when the open circuit is created by the input source switch, the first DC power is input into the working inverter to generate the high-frequency power; wherein, when the closed circuit is created by the input source switch, the second DC power is input into the working inverter to generate the high-frequency power.

4. The induction cooker according to claim 3, further comprising two voltage dividers respectively connected to the bridge diode and the battery unit, wherein the two voltage dividers are connected to the microcontroller unit, and the two voltage dividers are configured to sample a voltage of the first DC power and a voltage of the second DC power to the microcontroller unit; wherein, the microcontroller unit is configured to control the input source switch to create the open circuit or the closed circuit according to the voltage of the first DC power and the voltage of the second DC power that are sampled by the two voltage dividers.

5. The induction cooker according to claim 1, wherein the battery unit includes a plurality of batteries, and the batteries are connected in series, so that the difference between the voltage of the second DC source and the working voltage is less than or equal to 5% of the working voltage.

6. The induction cooker according to claim 1, further comprising a boost module connected to the battery unit and the working inverter, wherein the boost module is configured to increase the voltage of the second DC source, so that the difference between the voltage of the second DC source and the working voltage is less than or equal to 5% of the working voltage.

7. The induction cooker according to claim 1, further comprising a line filter connected between the AC power port and the bridge diode, wherein the line filter is configured to filter noise from the AC source before the noise passes into the bridge diode.
